(19) United States
(12) Patent Application Publication
(10) Pub. No.: US 2024/0249151 A1
(43) Pub. Date: Jul. 25, 2024

(54) REINFORCEMENT LEARNING BY SOLUTION OF A CONVEX MARKOV DECISION PROCESS

(71) Applicant: DeepMind Technologies Limited, London (GB)

(72) Inventors: Tom Ben Zion Zahavy, London (GB); Brendan Timothy O'Donoghue, London (GB); Guillaume Desjardins, London (GB); Satinder Singh Baveja, Ann Arbor, MI (US)

(21) Appl. No.: 18/558,894

(22) PCT Filed: May 27, 2022
(86) PCT No.: PCT/EP2022/064495

§ 371 Date: Nov. 3, 2023

Related U.S. Application Data
(60) Provisional application No. 63/194,833, filed on May 28, 2021.

(51) Int. Cl. G06N 3/092; G06N 3/045

(52) U.S. Cl. CPC G06N 3/092; G06N 3/045

(57) ABSTRACT

The actions of an agent in an environment are selected using a policy model neural network which implements a policy model defining, for any observed state of the environment characterized by an observation received by the policy model neural network, a state-action distribution over the set of possible actions the agent can perform. The policy model neural network is jointly trained with a cost model neural network which, upon receiving an observation characterizing the environment, outputs a reward vector. The reward vector comprises a corresponding reward value for every possible action. The training involves a sequence of iterations, in each of which (a) a cost model is derived based on the state-action distribution of a candidate policy model defined in one or more previous iterations, and subsequently (b) a candidate policy model is obtained based on reward vector(s) defined by the cost model obtained in the iteration.

### BACKGROUND

This specification relates to methods and systems for solving a convex Markov decision process (MDP), such as to train a neural network to choose actions to be performed by an agent in an environment.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes how a system implemented as computer programs in one or more computers in one or more locations can perform a method to train (that is, adjust the parameters of) an adaptive system (“neural network”) used to select actions to be performed by an agent interacting with an environment.

In broad terms a reinforcement learning (RL) system is a system that selects actions to be performed by a reinforcement learning agent, or simply agent, interacting with an environment. In order for the agent to interact with the environment, the system receives data characterizing the current state of the environment and selects an action to be performed by the agent in response to the received data. Data characterizing (at least partially) a state of the environment is referred to in this specification as “state data”, or an “observation”. The environment may be a real-world environment, and the agent may be an agent which operates on the real-world environment. Alternatively, the environment may be a simulated environment. Thus the term “agent” is used to embrace both a real agent (e.g. robot) and a simulated agent, and the term “environment” is used to embrace both types of environment.

In general terms, the disclosure proposes that actions of the agent are selected using a policy model neural network which implements a policy model defining, for any observed state of the environment characterized by an observation received by the policy model neural network, a “state-action distribution” over the set of possible actions the agent can perform. In other words, the policy model, conditioned on an observation of the environment characterizing the state of the environment, assigns a numerical value to each possible action, and the numerical values are used to select the action of the agent. The policy model is such that the actions selected for the agent cause the agent to perform a task in the environment. The policy model neural network is jointly trained with a cost model neural network which, upon receiving an observation characterizing the environment, outputs a reward vector. The reward vector comprises a corresponding reward value (a negative cost) for every possible action; in other words, the cost model neural network implements a cost model which defines a reward value which the policy model should be given for selecting any given corresponding action, given the state of the environment as characterized by the observation. The training involves a sequence of iterations, in each of which (a) a cost model is derived based on the state-action distribution of a candidate policy model defined in one or more previous iterations (in the first iteration, the cost model may be derived using a predetermined default policy model), and subsequently (b) a candidate policy model is obtained based on reward vector(s) defined by the cost model obtained in the iteration. The cost model may be selected such that the reward vector defined by the cost model maximizes a Lagrangian function. The Lagrangian function is based on one or more of the previously generated candidate policy models (or, in the first iteration, on a default policy model) and on a convex function of the reward vector. Each candidate policy model may be selected to maximize the expected reward of the action selected based on the corresponding state-action distribution, according to the reward value for that action according to the cost model obtained in that iteration.

The Lagrangian function may be chosen to ensure that the iterative training results in training the policy model to produce a state-action distribution which minimizes the convex function when the convex function takes the state-action distribution as its input. For example, the Lagrangian function may be (a) a dot product of the reward vector corresponding to the cost model with the state-action distribution defined by at least one previously generated candidate policy model, minus (b) the convex function of the corresponding reward vector (in some examples below denoted ƒ*). Thus, the reward value components of the reward vector are respective Lagrangian multipliers, and the argument of the convex function is the reward vector, rather than the state-action distribution directly.

For some convex functions, the result of this procedure is that the candidate policy model converges to one giving the optimal state-action distribution (i.e. the one having the lowest value of the convex function). More generally, though, it can be shown that during the iterative procedure the sequence of candidate policy models produced is such that the average of their respective state-action distributions converges to an optimal state-action distribution which minimizes the convex function (or more exactly, a function ƒ of which the convex function ƒ* is a convex conjugate), irrespective of which convex function it is. Note that this is not true of existing reinforcement learning algorithms in which training of a policy model is based on minimizing a cost function, since such algorithms only converge to an optimal solution only for specific choices of cost function.

For that reason, in the present system may, following the sequence of the plurality of iterations, generate an average distribution (defined for each action and each state of the environment as characterized by the observations) which is an average of the respective distributions for the respective candidate policy models obtained in each of a plurality of (and optionally all of) the iterations. For example the average distribution may be derived based on the average of the state-action distributions of the candidate policy models generated after a threshold number of iterations has occurred. Alternatively, the average distribution may be derived based on the average of the state-action distributions of the candidate policy models generated in a predetermined number of iterations which are the last iterations in the sequence of iterations.

The subject matter described in this specification can be implemented in particular embodiments so as to realize one or more of the following advantages. First, using the method, a policy model can be derived (e.g. based on the average distribution mentioned above) which minimizes any convex function, however that convex function is chosen. This gives a user of the method greater flexibility in choosing the convex function, and accordingly means that for certain reinforcement learning tasks better learning performance will be achieved. That is, the trained policy model is able to control the agent to perform a task related to the convex function with greater accuracy than in a known method, and/or with reduced requirements for computational resources during the training process. Indeed, the present method facilitates some reinforcement learning tasks which cannot be solved by existing reinforcement learning techniques. This is because for some tasks it is easier to design a convex function which reflects the task than to design a reward function, which many conventional reinforcement learning techniques require. Further, the present technique can be used to enhance an existing reinforcement learning technique, such as by providing a way to implement the existing reinforcement learning technique while ensuring that the policy model which is obtained obeys a desirable constraint.

The policy model neural network and cost model neural network, defining respectively the policy model and the cost model, may take any conventional form. For example, either or both could be a feed forward network, and either or both may comprise one or more convolutional layers, particularly in the case that the observations are in the form of still or moving images.

In one case, the policy model neural network may be implemented as one of a system of multiple neural network models. For example, the system may be an Actor-Critic system comprising an Actor neural network, which in this case plays the role of the policy network, and a Critic neural network (which may be the cost model neural network, or may be implemented separately). In another example, the system may be a Generative Adversarial Network (GAN) which comprises a generator neural network (which in this case plays the role of the policy neural network), and a discriminator neural network (which may be the cost model neural network, or may be implemented separately). The generator neural network is trained, based on a training set of data items (“samples”) selected from a distribution (a “sample distribution”), to generate samples from the distribution. The generator neural network, once trained, may be used to generate samples from the sample distribution based on latent values (or simply “latents”) selected from a latent value distribution (or “latent distribution”). The discriminator neural network is configured to distinguish between samples generated by the generator network and samples of the distribution which are not generated by the generator network.

The generator and discriminator may be trained together (that is, as part of a training process in which multiple successive updates to the generator and discriminator are simultaneous or interleaved). In this process, the generator may be trained to generate data from which an action of the agent can be selected (e.g. a distribution over the possible actions) based on latents which are observations of the environment. The discriminator is trained using examples of the inputs to and outputs of the generator, and additionally using a training database of observations, and corresponding actions which are chosen (e.g. by a human operator) to solve the task, given the state of the environment as shown in the observations.

As noted above, the action of the agent is determined based on the policy model. The action of the agent for a given state may, for example, be chosen by treating the state-action distribution for a given policy model as a probability distribution, and selecting the action at random from the set of possible actions with a probability proportional to the corresponding numerical value for that action according to the state-action distribution. Alternatively, the action may be selected as the action for which state-action distribution is highest.

The cost model depends upon the task which the agent is to perform. The reward vector (which may be denoted −λ) generated by the cost model for a given state of the environment is composed of a reward value for each of the plurality of respective actions. The reward value indicates the contribution the respective action makes, when carried out by the agent, in causing the agent to carry out the task.

The algorithm used to obtain the cost model (which may be denoted Alg_{λ}) may employ training data (a training database) comprising a plurality of training data items. Each training data item comprises an instance of a state of the environment (observations) and a corresponding action which were performed by the agent on the environment when it was in that state. For example, the actions may be actions chosen by an expert (e.g. a human expert) to cause the agent to perform the task. Optionally, each of the training data items further contains a corresponding training data item reward value (e.g. derived from the most recently generated cost model), indicative of the contribution of the action to solving the task. These training items may be grouped such that each group of training items relates to a trajectory which is a sequence of states of the environment at consecutive time steps, and corresponding actions, e.g. while a task is performed in T steps.

Optionally, the training data may be pre-generated (i.e. at a time before the present method is used to produce the policy model). Alternatively, further training data items may be produced and added to the training database as the method is performed. For example, in some or all of the iterations, the latest candidate policy model may be used to select, for each of one or more observations, an action to be performed by the agent. New training data items may be generated and stored in the database, each of which is a tuple of the observation and the selected action. Optionally, the action may be used to generate a training data item reward value which is included in the new training data item added to the database. The training data item reward value may be produced by an external neural network for allocating rewards, or using the latest cost model (e.g. as the reward value for the action which is the corresponding component of the reward vector defined by the cost model given the state of the environment characterized by the observation).

As noted above, the method relates to a convex function (which may be denoted ƒ*). The convex function may have been obtained starting from an objective function (which may be denoted ƒ) by choosing the convex function as the Fenchel conjugate of the objective function. In this case, optionally, the algorithm Alg_{λ} used to obtain the cost model, in an iteration labelled as the k-th iteration (where k is an integer in the range 1 to an integer K, which is at least two), may simply be such that the reward vector −λ^{k} is given by λ^{k}=∇ƒ(d̅_{π}^{k-1}); that is, as the gradient of the objective function evaluated at d̅_{π}^{k-1}=Σⱼ₌₁^{k-1}d_{π}^{k-1}, where j is a dummy integer index. That is, the gradient of the objective function is evaluated over the average of the state-action distributions for the last (k−1) candidate policy models (i.e. the candidate policy models produced in the immediately preceding (k−1) iterations).

The algorithm for obtaining the policy model based on the reward vector (which may be denoted Alg_{π}), may also be any conventional algorithm. It may be iterative or not.

For example, in one case the policy model may be chosen (from a range of possible policy models which is defined by the architecture of the policy model neural network) as the policy model which maximizes a dot product of (i) the reward vector corresponding to the cost model obtained in the iteration and (ii) the distribution produced by the policy model. Optionally, this dot product may be evaluated as an average over the states in a plurality of training data items in the training database. Thus, the policy model is chosen based on the reward vectors for the training data items.

Optionally, the candidate policy model obtained in a certain one of the iterations may be obtained starting from the candidate policy model in the preceding iteration, e.g. by performing one or more update steps to it, where the update is performed based on the reward vector (−λ^{k}) for the cost model obtained in the iteration.

Optionally, the Lagrangian function may be chosen so as to implement one or more constraints on the candidate policy models, using one or more corresponding additional Lagrangian multipliers. For example, the constraint may force the candidate policy model to be chosen such that the entropy of the state-action distributions it produces is above a specific value (which may be denoted C), such as a predetermined value.

### DESCRIPTION OF THE FIGURES

Examples of the disclosure will now be described with reference to the following FIGURES.

FIG. 1 shows how an action selection system controls an agent operating in an environment.

FIG. 2 shows the structure of any exemplary action selection system according to the present disclosure.

FIG. 3 shows a method for training the action selection system of FIG. 2.

FIG. 4 shows experimental results comparing the performance of a trained action selection system with two known action selection systems.

Elements in different FIGURES having the same significance are indicated using the same reference numerals.

### DETAILED DESCRIPTION

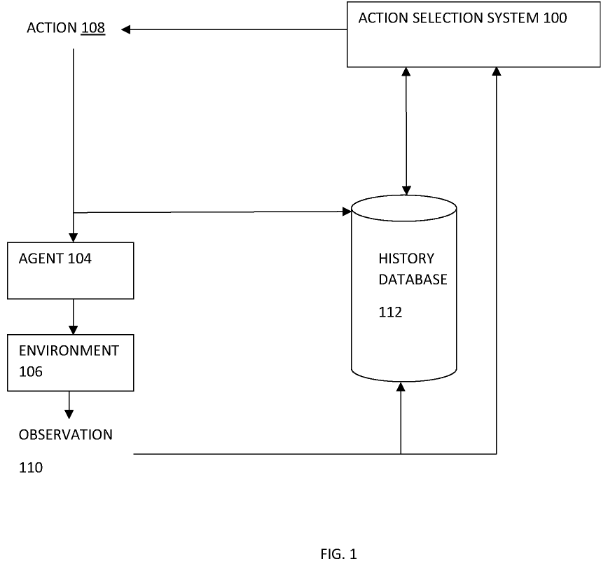

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task. The action selection system 100 does this by selecting actions 108 to be performed by the agent 104 at each of multiple time steps, denoted t. At each time step, the action selection system 100 is configured to process an input including, or consisting of, an observation 110 (which may be denoted s(t) which is one of a set of possible observations denoted S) characterizing the current state of the environment 106, to generate the action 108, denoted a(t). The actions 108 and observations 110 are stored in a history database 112.

The action selection system generates action a(t) according to a “policy” denoted π(s(t)). The policy π causes a chosen action a(t) to be selected, given the state s(t), with a probability distribution denoted π(s(t), a(t)). d_{π}(s, a) is a state-action stationary distribution (occupancy measure) caused by the policy π, and is one member of a space of possibilities (admissible stationary distributions) denoted [symbol] .

The policy π may be chosen by an iterative process, referred to as “learning”, e.g. based on training data which is the data stored in the training database 112. The training data is typically supplemented at intervals during the learning, by using the system of FIG. 1 to perform one or more trajectories (sequences of actions) for respective performances the task.

One type of learning is reinforcement learning (RL). In reinforcement learning, it is known to study a case in which there is a known reward r(s,a) which, in the case that the state of the environment is s, indicates the degree to which action a contributes to performing the task. The policy is selected according to:

$${max}_{{d}_{π} ∈ 𝒦} {\sum }_{s , a} r ( s , a ) {d}_{π} ( s , a ) \qquad ( 1 )$$

A significant body of work is dedicated to solving the RL problem defined by Eqn. (1) efficiently in challenging domains. However, not all decision-making problems of interest take this form. In particular, a more general convex MDP problem selects the policy w according to:

$${min}_{{d}_{π} ∈ 𝒦} f ( {d}_{π} ( s , a ) ) \qquad ( 2 )$$

where ƒ: [symbol] → [symbol] is a convex function. Later in this document is a list of known learning techniques having the general form of Eqn. (2) for specific corresponding choices of the function ƒ.

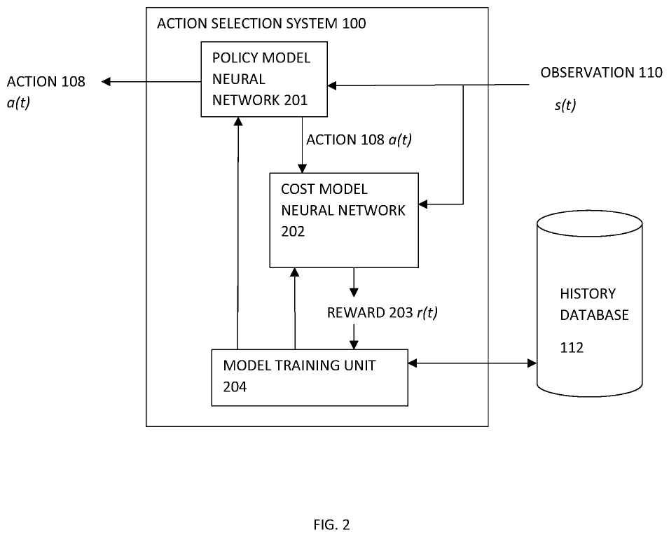

In an example, this disclosure proposes that training the action selection system 100 is performed using a system as described in FIG. 2, to produce a result, that is a policy π, which has a state-action distribution which is the solution of Eqn (2).

FIG. 2 shows the structure of the action selection system 100. The action selection system 100 comprises a policy model neural network 201, which, at time t, receives the observation 110 s(t) and generates the corresponding action 108 a(t). That is, the policy model neural network 201 defines the policy π (or “policy model”). The policy model neural network 201 includes a number of variable parameters (“weights”). A given setting of these weights corresponds to the policy model.

For example, the policy model neural network 201 may comprise a plurality of neural network layers arranged in a stack (sequence), such that a first layer of the stack receives the observation s(t) and each other successive layer receives the output of the preceding layer. Each layer generates its output as a function of its input defined by a respective subset of the weights. Particularly in the case that the observation 110 is an image, one or more of the layers may be a convolutional layer.

The policy model neural network 201 may generate the action 108 by the policy model neural network 201 generating, according to the policy π, a plurality of action scores which include a respective numerical value for each action in a set of possible actions denoted A. The action scores are used by the policy model neural network 201 to select the action 108 a(t) to be performed by the agent 104 at the time step t. For example, the control system may select the action 108 a(t) which has the highest score; or it may treat the action scores as defining a probability distribution over the possible actions (i.e. with each score being proportional to a respective probability for the corresponding action), and select the action 108 a(t) randomly from the probability distribution; or it may process the action scores using a soft-max function. The environment then transitions to a new state sₜ₊₁∈S according to some probability distribution P(·, sₜ, aₜ). Thus, the system is described by a Markov decision process (MDP) defined by the tuple (S, A, P, R). To this may be added a distribution d₀ from which the initial state s₁ may be sampled.

The policy model neural network 201 is trained (that is, its parameters are iteratively obtained) during a training process described below. As above, a given realization of policy model neural network 201 causes the policy neural network 201 to output a function of its inputs denoted π, which is called more simply a policy. Once the policy model neural network 201 is trained, it may select actions as described above indefinitely from an initial time denoted t=1, e.g. until a criterion is met indicating that the task is completed, e.g. at a time T.

During a training process, the action 108 a(t) is also transmitted to a cost model neural network 201. The cost model neural network 201 performs a function called a cost model, in which it generates a corresponding reward 203, denoted r(t), where rₜ˜R(sₜ, aₜ), indicative of the contribution of the action a(t) to solving the task. A model training unit 204 receives the reward, and uses the reward to update the parameters of the policy model neural network 201, e.g. to increase the expected reward for future iterations t.

One possible measure of the performance (i.e. performance metric) of the action selection system 100 is:

$${J}_{π}^{a v g} = {lim}_{T \to ∞} \frac{1}{T} 𝔼 {\sum }_{t = 1}^{T} {r}_{t} . \qquad ( 3 )$$

Alternatively, a discount parameter γ (a scalar with a value less than one) may be defined, and the performance metric may be defined as:

$${J}_{π}^{γ} = ( 1 - γ ) 𝔼 {\sum }_{t = 1}^{∞} {γ}^{t} {r}_{t} . \qquad ( 4 )$$

In this case, the system is described by a Markov decision process (MDP) defined by the tuple (S, A, P, R, γ, d₀).

As noted above, the policy π results in a state-action distribution (state-action occupancy measure) denoted d_{π}(s, a), which a measure of how often the agent visits each possible state-action combination (s,a) (e.g. during an average trajectory). For any policy π, the state-action distribution d_{π} may be defined such that the standard RL objective (the average reward or the discounted reward) is the linear product (sum over possible states and actions) of d_{π}(s, a) and the corresponding reward r(s, a). Given an state-action distribution d_{π}(s, a) we can recover the policy π by setting π(s, a)=d_{π}(s, a)/Σₐ, d_{π}(s, a′) where the sum is over all a′∈A. This assumes that Σₐ, d_{π}(s, a′)>0. In the analysis below this need not be the case, and in such cases we define π(s, a)=1/A.

Specifically, let [symbol] _{π}(st=·) denote the probability measure over the states at time t under policy π. In the case of the performance measure of Eqn. (3) (the average reward case):

$${d}_{π}^{a v g} = {lim}_{T \to ∞} \frac{1}{T} 𝔼 {\sum }_{t = 1}^{T} {ℙ}_{π} ( {s}_{t} = s ) π ( s , a ) ,$$

while in the case of the performance measure of Eqn. (4) (the discounted reward case):

$${d}_{π}^{γ} = ( 1 - γ ) 𝔼 {\sum }_{t = 1}^{∞} {γ}^{r} {ℙ}_{π} ( {s}_{t} = s ) π ( s , a ) .$$

In this case, it can be shown that both Eqns. (3) and (4) can be written J_{π}=Σ_{s,a} r(s, a) d_{π}(s, a).

In each case, the space of possibilities [symbol] for d_{π}(s, a) is a respective polytope given, in the average reward case, by:

$${𝒦}_{a v g} = \{ {d}_{π} \vert {d}_{π} \geq 0 , {\sum }_{a , s} {d}_{π} ( s , a ) = 1 , {\sum }_{a} {d}_{π} ( s , a ) = {\sum }_{{s}^{′} , {a}^{′}} P ( s , {s}^{′} , {a}^{′} ) {d}_{π} ( {s}^{′} , {a}^{′} ) ∀ s ∈ S \}$$

and for the discounted case it is given by:

$${𝒦}_{γ} = \{ {d}_{π} \vert {d}_{π} \geq 0 , {\sum }_{a} {d}_{π} ( s , a ) = ( 1 - γ ) {d}_{0} ( s , a ) + γ {\sum }_{{s}^{′} , {a}^{′}} P ( s , {s}^{′} , {a}^{′} ) {d}_{π} ( {s}^{′} , {a}^{′} ) ∀ s ∈ S \}$$

Being a polytope implies that [symbol] is a convex and compact set.

By selecting the reward function rₜ˜R (sₜ, aₜ) as explained below based on ƒ, the convex MDP problem of Eqn. (2) can be solved within the framework of FIGS. 1 and 2. The convex MPD problem is defined for the tuple (S, A, P, ƒ) in the average cost case and (S, A, P, ƒ, γ, d₀) in the discounted case. This tuple is defining a state-action occupancy's polytope [symbol] , and the problem is to find a policy π whose state occupancy d_{π} is in this polytope and minimizes the function ƒ. Since both ƒ: [symbol] → [symbol] and the set [symbol] are convex, this is a convex optimization problem.

The problem may be addressed by defining a reward function which employs a Fenchel conjugate. For a function ƒ: [symbol] → [symbol] ∪{−∞, ∞}, where n is an integer, its Fenchel conjugate is denoted ƒ*: [symbol] → [symbol] ∪{−∞, ∞} and defined, for an n-component vector x, as ƒ*(x):=sup_{y}x·y−ƒ(y), i.e. the maximum, over all possible real values of the n components of the vector y, of (x·y−ƒ(y)). The Frenchel conjugate is always convex (when it exists), even if ƒ is not. Furthermore, the biconjugate,ƒ** (i.e. (ƒ*)*) equals ƒ if and only if ƒ is convex and lower semi-continuous.

Using this, the convex MDP problem (Eqn. (2)) can be expressed as:

$${min}_{{d}_{π} ∈ 𝒦} f ( {d}_{π} ( s , a ) ) = {min}_{{d}_{π} ∈ 𝒦} {max}_{λ ∈ Λ} ( λ \cdot {d}_{π} - f * ( λ ) ) = {max}_{λ ∈ Λ} {min}_{{d}_{π} ∈ 𝒦} ( λ \cdot {d}_{π} - f * ( λ ) ) \qquad ( 5 )$$

Where λ is a vector of Lagrangian multipliers having a component for each (s,a) combination. Λ is the closure of the (sub-)gradient space {∂ƒ(d_{π})|d_{π}∈ [symbol] }, which is a convex set. This is a convex-concave saddle-point problem. A Lagrangian can be defined as

$$ℒ ( {d}_{π} , λ ) : = λ \cdot {d}_{π} - f * ( λ ) \qquad ( 6 )$$

For a fixed λ∈Λ, minimizing the Lagrangian is a standard RL problem of the form of Eqn. (1), i.e. equivalent to maximizing a reward r=−λ.

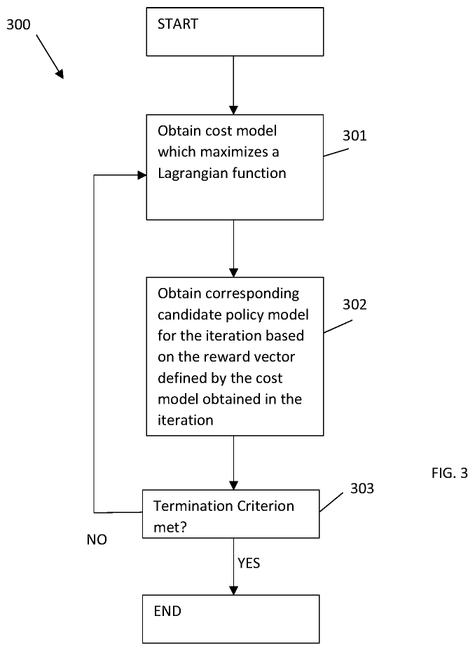

To solve Eqn. (5), an iterative training process 300 according to the present disclosure is performed as shown in FIG. 3. The training process 300 is an example of a computer-implemented method, implemented on one or more computers in one or more locations.

The training process 300 is performed in K iterations, where K is an integer. The iterations are counted by an integer variable k, where k=1, . . . . K. Each iteration results in a corresponding set of parameters for the cost model neural network 202 (i.e. a corresponding cost model), such that the cost model obtained in the k-th iteration defines a vector λ^{k}. For each observed state s of the environment, λ^{k} defines a corresponding reward value −λ(s, a) for each action a of the set of actions A, indicating a contribution the action a makes to performing the task. Each iteration also produces a corresponding set of parameters for the policy model neural network 201 (i.e. a corresponding candidate policy model π^{k}), defining a corresponding state-action distribution d_{π}^{k} over the possible realisations of (s, a). It can be shown that an optimal policy d*_{π} defined as

$$( \frac{1}{K} ) {\sum }_{k = 1}^{K} {d}_{π}^{k}$$

converges, as K increases, to the solution of Eqn. (2).

Specifically, in step 301, an algorithm denoted Alg_{λ} is performed to obtain the corresponding cost model, which defines the vector of Lagrange multipliers λ^{k}. The algorithm Alg_{λ} obtains the cost model such that λ^{k} which maximizes a Lagrangian function which is a function of the state-action distributions from the previous iterations, i.e. {d_{π}¹, d_{π}², . . . , d_{π}^{k-1}}. In other words, the Lagrangian function is based on the state-action distribution defined by at least one (or all) of the previously generated candidate policy models {π¹, π², π^{k-1}} and the convex function ƒ*(λ^{k}) of the reward vector defined by the corresponding cost model λ^{k}. This step can be implemented by optimizing the variable parameters of cost model neural network 202 of FIG. 2 without changing the variable parameters of the policy model neural network 201.

Then in step 302, an algorithm (e.g. a known RL algorithms) denoted Alg_{π}, takes as an input a reward vector defined by λ^{k} (such as by −λ^{k}) and trains the variable parameters of the policy model neural network 201, thereby returning (producing) the state-action occupancy measure (distribution) d_{π}^{k} (or from another point of view, defining a corresponding “candidate” policy model π^{k}). d_{π}^{k} minimizes Eqn. (1) in the case that the reward r(s, a)=−λ(s, a). This step can be implemented by training the policy model neural network 201 of FIG. 2, e.g. by a known RL algorithm, without changing the variable parameters of the cost model neural network 202.

The pair of steps 301, 302 is performed iteratively, each time increasing k by 1, until, in step 303, it is determined that a termination criterion is met, e.g. k=K. Steps 301 and 302 can be performed by the model training unit 204, but following each performance of the pair of steps additional training data can be collected, e.g. by carrying out one or more trajectories representing corresponding performances of the task by the system of FIG. 1 using the most recent update of the policy model neural network 201 to generate the actions 108. In performing steps 301, 302 of the training process, the model training unit 204 has access, via the history database 112, to the history of observations 110 and rewards 203, but also to the results from previous iterations, in particular λ^{k} and d_{π}^{k}.

The training process 300 of FIG. 3 can alternatively be expressed as (“Algorithm 1”):

| 1: | Input convex-concave payoff [symbol] : [symbol] × Λ → [symbol] |
|---|---|
| (i.e. a real number), Alg_{λ}, Alg_{π}, K ∈ N (i.e. a natural number) | |
| 2 | for k = 1, . . . , K do |
| 3 | λ^{k} = Alg_{λ}(d_{π}¹, d_{π}², . . . . d_{π}^{k-1}, [symbol] ) |
| 4 | d_{π}^{k} = Alg_{π}, (−λ^{k}) |
| 5 | end for |
| 6 | $Return \overline{{d}_{π}^{K}} = ( \frac{1}{K} ) {\sum }_{k = 1}^{K} {d}_{π}^{k} , \overline{{λ}^{k}} == ( \frac{1}{K} ) {\sum }_{k = 1}^{K} {λ}^{k} .$ |

Here d̅_{π}^{K} approaches the solution to Eqn. (2) as K increases. It is an average over the K iterations of the respective state-action distribution d_{π}^{k} for the respective candidate policy model π^{k} obtained in each of those iterations. Note that in a variation, the average can be taken omitting some of the iterations (e.g. the first j iterations, where j is an integer less than K), and the result will still converge to the solution of Eqn. (2) as K increases. A policy model π̅^̅{̅K̅}̅ can be determined, as explained above, by using the average state-action distribution d̅_̅{̅π̅}̅^̅{̅K̅}̅ to derive policy model π̅^̅{̅K̅}̅, that is, a policy which defines a state-action distribution equal to the average state-action distribution d̅_̅{̅π̅}̅^̅{̅K̅}̅. Specifically,

$$\overline{{π}^{K}} ( s , a ) = \overline{{d}_{π}^{K}} ( s , a ) / {Σ}_{a′} \overline{{d}_{π}^{K}} ( s , {a}^{′} ) .$$

Algorithm 1 defined above is referred to as a meta-algorithm, because it employs supplied sub-routines Alg_{λ} and Alg_{π}. The meta-algorithm may be thought of as describing a zero-sum game between the policy model neural network 201 and the cost model neural network 202, which may respectively be considered as a “policy player” and a cost player”. From the point of view of the policy model neural network 201, the game is bilinear, and so for fixed rewards produced by the cost model neural network 202, step 302 reduces to the standard RL problem. Algorithm 1, in particular steps 3 and 4, is performed by the model training unit 204.

Note that various choices for ƒ, Alg_{λ} and Alg_{π} allow Algorithm 1 to implement many known policy model training problems, as shown in Table 1. In the table FTL denotes “follow the leader”, a well-known online convex optimization (OCO) problem, OMD denotes “online mirror decent”, c denotes a context variable, C denotes a convex set, and d_{E} is defined below. Note that ƒ in the case of diverse skill discovery is concave.

TABLE 1

| Convex Objective ƒ | Alg_{λ} | Alg_{π} | Application |
|---|---|---|---|
| λ · d_{π} | FTL | RL | Standard RL with − λ as |
| | | | stationary reward vector |
| \|\|d_{π} − d_{E}\|\|₂² | FTL | Best response | Some known forms of |
| | | | Apprenticeship |
| | | | learning (AL) |
| d_{π} · log(d_{π}) | FTL | Best response | Pure exploration |
| \|\|d_{π} − d_{E}\|\|_{∞} | OMD | Best response | Other known forms of AL |
| [symbol] _{c} [λ_{c} · (d_{π} − d_{E}(c))] | OMD | Best response | Inverse RL in contextual |
| | | | MDPs |
| λ₁ · d_{π} s · t · λ₂ − | OMD | RL | Constrained MDPs |
| d_{π} ≤ c | | | |
| Dist (d_{π}, C) | OMD | Best response | Feasibility of convex- |
| | | | constrained MDPs |
| min_{λ}_{₁}_{,λ}_{₂}_{,..,,λ}_{ₖ} d_{π}^{k}λₖ | OMD | RL | Adversarial Markov |
| | | | Decision Processes |
| max_{λ∈∧}λ · (d_{π} − d_{E}) | OMD | RL | Online AL, Wasserstein |
| | | | GAIL |
| KL(d_{π}\|\|d_{E}) | FTL | RL | GAIL, state marginal |
| | | | matching |
| − [symbol] _{z}KL(d_{π}^{z}\|\| [symbol] ₖd_{π}^{k}) | FTL | RL | Diverse skill discovery |

We now explain the algorithms of Table 1 in more detail. In the discussion, it is assumed, that λₘₐₓ<1, or ensured by enforcing this in Alg_{λ}.

In the case of FTL, Alg_{λ} can be implemented as:

$${λ}^{k} = arg {max}_{λ ∈ Λ} {\sum }_{j = 1}^{k - 1} ℒ ( {d}_{π}^{j} , λ ) = arg {max}_{λ ∈ Λ} ( λ \cdot {\sum }_{j = 1}^{k - 1} {d}_{π}^{j} - Kf * ( λ ) ) = ∇ f ( \overline{{d}_{π}^{k - 1}} ) \qquad ( 7 )$$

where

$$\overline{{d}_{π}^{k - 1}} = {Σ}_{j = 1}^{k - 1} {d}_{π}^{j}$$

and the last inequality follows from the fact that (∇ƒ*)⁻¹=∇ƒ. The second equality shows that the corresponding variable parameters of the cost model neural network 202 for the iteration are obtained to produce a cost model which maximizes a Lagrangian function (Σⱼ₌₁^{k-1} [symbol] (d_{π}^{j}, λ)) based on the state-action distribution defined by the candidate policy models generated in previous iterations, and on the convex function ƒ* of the reward vector −λ defined by the corresponding cost model neural network 202.

In the case of OMD, Alg_{λ} can be implemented as:

$${λ}^{k} = arg {max}_{λ ∈ Λ} ( ( λ - {λ}^{k - 1} ) \cdot {∇}_{λ} ℒ ( {d}_{π}^{k - 1} , {λ}^{k - 1} ) + {α}_{k} {B}_{r} ( λ , {λ}^{k - 1} ) ) \qquad ( 8 )$$

where aₖ is a learning rate and Bᵣ is a Bregman divergence, as described in L. M. Bregman, “The relaxation method of finding the common point of convex sets and its application to the solution of problems in convex programming”, 1967. OMD is equivalent to a linearized version of the known technique “Follow the Regularized Leader” (FTRL). If Bᵣ(λ,λ^{k-1}) is of the form Bᵣ(x) for x=λ−λ^{k-1}, Bᵣ(x)=0.5∥x∥₂² is equivalent to gradient descent, and for Bᵣ(x)=x·log(x) multiplicative weights are obtained. The right hand side of Eqn. (8) is also a Lagrangian function, so once again the corresponding cost model neural network 202 for the iteration is obtained defining a cost model which maximizes a Lagrangian function based on the state-action distribution defined by the candidate policy models generated in previous iterations, and on the convex function ƒ* of the reward vector −λ defined by the corresponding cost model defined by the cost model neural network 202.

In the case of best response, Alg_{π} can be implemented by

$${d}_{π}^{k} = arg {min}_{{d}_{π} ∈ 𝒦} ℒ ( {d}_{π} , {λ}^{k} ) = arg {min}_{{d}_{π} ∈ 𝒦} ( {d}_{π} \cdot {λ}^{k} - f * ( {λ}^{k} ) ) = arg {min}_{{d}_{π} ∈ 𝒦} ( {d}_{π} \cdot ( - {λ}^{k} ) ) ,$$

which is an RL problem for maximizing the reward (negative cost) −λ^{k}. It can be performed by any known RL algorithm. For example, tabular Q-learning executed for sufficiently long and with a suitable exploration strategy will converge to the optimal policy. Alternatively, a deep neural network can be parameterized to represent Q-values, and if the network has sufficient capacity, then similar guarantees may hold.

Alternatively, to reduce the computational cost of best response, Alg_{π} can be implemented by “approximate best response”, defined using the known “Probably approximately correct” (PAC) framework. The policy model neural network 201 is said to be PAC(ϵ, δ) if it finds an ϵ-optimal policy to an RL problem with a probability of at least (1-δ). In additional, a policy π′ is ϵ-optimal if its state occupancy d′_{π} is such that:

$${max}_{{d}_{π} ∈ 𝒦} {d}_{π} \cdot ( - {λ}^{k} ) - {d}_{π}^{′} \cdot ( - {λ}^{k} ) \leq ϵ$$

Algorithms such as Y. Jin et al, “Efficiently solving mdps with stochastic mirror descent”, 2020, and T. Lattimore et al, “Pac bounds for discounted mdps”, 2012 provide explicit ways of producing an ϵ-optimal policy π′.

Another possibility would be for Alg_{π} to be implemented as a single RL update to the policy model neural network 201, with a cost λ^{k}. The reward is known and deterministic but non-stationary, whereas in standard RL it is unknown, stochastic and stationary.

Another possibility would be for Alg_{π} to be implemented by a known Mirror Descent Policy Optimization (MDPO), as described by L. Shani et al “Optimistic policy optimization with bandit feedback”, 2020.

Note that Eqn. (2) can be generalized to add one or more constraints, as:

$${min}_{{d}_{π} ∈ 𝒦} f ( {d}_{π} ( s , a ) ) subject to {g}_{i} ( {d}_{π} ) \leq 0 , i = 1 , … , m \qquad ( 9 )$$

where ƒ and the constraint functions gᵢ are convex. The techniques described above to solve Eqn. (2) can be generalized to solve Eqn. (9). A generalized Lagrangian function is introduced, based on parameters ζᵢ, μ₁ (for each i=1, . . . , m) and v, where v and each ζᵢ are vectors having components for each (s, a), and each μ₁ is a scalar, as:

$$ℒ ( {d}_{π} , {μ}_{1} , {μ}_{2} , … , {μ}_{m} , v , {ζ}_{1} , … , {ζ}_{m} ) = v \cdot {d}_{π} - f * ( v ) + {\sum }_{i = 1}^{m} ( {d}_{π} \cdot {ζ}_{i} - {μ}_{i} {g}_{i}^{*} ( {ζ}_{i} / {μ}_{i} ) \qquad ( 10 )$$

which is convex in d_{π} and concave in (v, μ₁, μ₂, . . . , μₘ, ζ₁, . . . , ζₘ) since it includes the perspective transform of the functions gᵢ. The generalized Lagrangian function involves a cost vector v+Σᵢ₌₁^{m} ζᵢ, linearly interacting with the d_{π}, so it can be solved using the system of FIGS. 1 and 2. Alg_{λ} can be implemented using OMD jointly on the variables (v, μ₁, μ₂, . . . , μₘ, ζ₁, . . . , ζₘ). Another option would be to generalize FIGS. 1 and 2, to define a three player game, with two cost model neural networks replacing cost model neural network 202 in FIG. 2 and defining respective cost models. In Alg_{λ} both of the cost model neural networks may be updated, e.g. concurrently or sequentially. One cost model chooses (v, ζ₁, . . . , ζₘ) and the other μ₁, μ₂, . . . , μₘ.

As indicated in Table 1, if ƒ is ∥dπ−d_{E}∥₂², the example of FIGS. 1 and 2 performs apprenticeship learning, in the formulation of P. Abbeel and A. Y. Ng, “Apprenticeship learning via inverse reinforcement learning”, 2004. Here d_{E} is an estimated expert state occupancy measure. Considering the problem as minimizing the convex function ƒ=∥d_{π}−d_{E}∥, the complex conjugate ƒ* is given by ƒ*(y)=y·d_{E} if ∥y∥_{*}≤1, and ∞ otherwise, where |·|_{*} denotes the dual norm. Using this in Eqn. (5) gives

$${min}_{{d}_{π} ∈ 𝒦} ‖ {d}_{π} - {d}_{E} ‖ = {min}_{{d}_{π} ∈ 𝒦} {max}_{λ ∈ Λ} ( λ \cdot {d}_{π} - λ \cdot {d}_{E} )$$

This can be solved using OMD as Alg_{λ} and best response/RL as Alg_{π}, giving an implementation similar to U. Syed et al, “A game-theoretic approach to apprenticeship learning”, 2008. Alternatively, it can be solved using FTL as Alg_{λ} and best response as Alg_{π}, giving a result similar to Abbeel and Ng. The algorithm finds d_{π}∈K which has the largest inner-product (best response) with the negative gradient (i.e. FTL).

Two popular approaches for learning are generative adversarial imitation learning (GAIL) (J. Ho et al, “Generative adversarial imitation learning”, 2016) for AL, and “Diversity is all you need” (DIAYN) (B. Eysenbach et al, “Diversity is all you need: learning skills without a reward function”, 2019) for diverse skill discovery. As shown in Table 1, these algorithms may be recovered by appropriate choice off and using FTL as Alg_{λ} and RL as Alg_{π}.

Experiments were performed using an example of the present disclosure. In one experiment, the formulation of DIAYN used in Table 1, with Alg_{π} implemented using the Impala algorithm (L. Espeholt et al, “IMPALA: Scalable distributed deep-RL with importance weighted actor-learner architectures), was compared with the bespoke implementation in Eysenbach et al., comparing the reward that results from an FLT cost model defined by the cost model neural network 202 with the mutual-information reward used in Eysenbach et al. The environment was a 9×9 gridworld, where the agent could move along four cardinal directions, and the task was the maximization of undiscounted rewards over episodes of length 32. It was found that the performance of Eysenback et al could be recovered using a system as shown in FIGS. 1 and 2.

Another experiment focused on an MDP with a convex constraint, where the goal is to maximize the extrinsic reward provided by the environment with the constraint that the entropy of the state-action occupancy measure must be bounded below. In other words, the agent must solve

$${max}_{{d}_{π} ∈ 𝒦} {\sum }_{s , a} r ( s , a ) {d}_{π} ( s , a )$$

subject to H(d_{π})≥C, where H denotes entropy and C>0 is a constant. The policy that maximizes the entropy over the MDP acts to visit each state as close to uniformly often as is feasible. So, a solution to this convex MDP is a policy that, loosely speaking, maximizes the extrinsic reward under the constraint that it explores the state space sufficiently. The presence of the constraint means that this is not a standard RL problem in the form of Eq. (1). However, this problem can be solved using the techniques developed in this disclosure, for the solution of Eqn. (9).

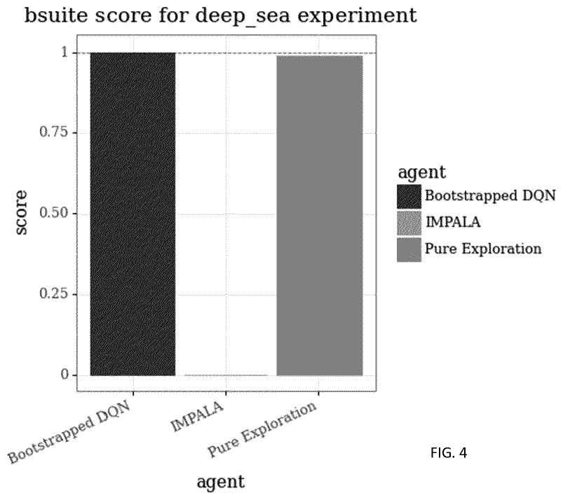

The approach was evaluated on the bsuite environment ‘Deep Sea’ (I. Osband et al, “Behaviour suite for reinforcement learning”, 2019), which is a hard exploration problem where the agent must take the exact right sequence of actions to discover the sole positive reward in the environment. In this domain, the features are one-hot state features, and the experiment evaluated d_{π} by counting the state visitations. For these experiments C was chosen to be half the maximum possible entropy for the environment, which was computed at the start of the experiment and held fixed thereafter. The agent was trained using the (non-stationary) Impala algorithm as Alg_{π}, and FTL as Alg_{λ}. The results are presented in in FIG. 4, which compares the basic Impala agent, the entropy-constrained Impala agent according to the example of the present disclosure, and a bootstrapped Deep Q-network (DQN) from I. Osband et al. It is known that algorithms that do not properly account for uncertainty cannot in general solve hard exploration problems. This explains why the basic Impala algorithm, normally considered a strong baseline, has such poor performance on this problem. Bootstrapped DQN accounts for uncertainty via an ensemble, and consequently has good performance. Surprisingly, the entropy regularized Impala agent performs approximately as well as bootstrapped DQN, despite not handling uncertainty. This suggests that the entropy constrained approach, solved using Algorithm 1, can be a reasonably good heuristic in hard exploration problems.

There now follows a more detailed discussion of the environments and agents to which the disclosed methods can be applied.

In implementations the observation relates to a real-world environment and the selected action relates to an action to be performed by a mechanical agent. For example the training could be performed in a real-world environment or in a simulation of a real-world environment. The method may then use the trained or partially trained action selection neural network in the real-world e.g. to control a mechanical agent to perform the task while interacting with a real-world environment by obtaining the observations from one or more sensors sensing the real-world environment and using the policy output to select actions to control the mechanical agent to perform the task.

Optionally, in any of the above implementations, the observation at any given time step may include data from a previous time step that may be beneficial in characterizing the environment, e.g., the action performed at the previous time step.

The action selection neural network 102 can be implemented with any appropriate neural network architecture that enables it to perform its described function. In one example, the action selection neural network 102 may include an “embedding” sub-network, a “core” sub-network, and a “selection” sub-network. A sub-network of a neural network refers to a group of one or more neural network layers in the neural network. The embedding sub-network may be a convolutional sub-network, i.e., that includes one or more convolutional neural network layers, that is configured to process the observation for a time step. The core sub-network may be a recurrent sub-network, e.g., that includes one or more long short-term memory (LSTM) neural network layers, that is configured to process: (i) the output of the embedding sub-network, and (ii) a representation of an exploration importance factor. The selection sub-network may be configured to process the output of the core sub-network to generate action scores 114.

In implementations of the method the environment is a real-world environment. The agent may be mechanical agent such as a robot interacting with the environment to accomplish a task or an autonomous or semi-autonomous land or air or water vehicle navigating through the environment.

In general the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g. one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment. As used herein an image includes a point cloud image e.g. from a LIDAR sensor.

The actions may comprise control inputs to control a physical behavior of the mechanical agent e.g. robot, e.g., torques for the joints of the robot or higher-level control commands; or to control the autonomous or semi-autonomous land or air or sea vehicle, e.g., torques to the control surface or other control elements of the vehicle or higher-level control commands. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g. braking and/or acceleration of the vehicle.

In such applications the task-related rewards may include a reward for approaching or achieving one or more target locations, one or more target poses, or one or more other target configurations, e.g. to reward a robot arm for reaching a position or pose and/or for constraining movement of a robot arm. A cost may be associated with collision of a part of a mechanical agent with an entity such as an object or wall or barrier. In general a reward or cost may be dependent upon any of the previously mentioned observations e.g. robot or vehicle positions or poses. For example in the case of a robot a reward or cost may depend on a joint orientation (angle) or speed/velocity e.g. to limit motion speed, an end-effector position, a center-of-mass position, or the positions and/or orientations of groups of body parts; or may be associated with force applied by an actuator or end-effector, e.g. dependent upon a threshold or maximum applied force when interacting with an object; or with a torque applied by a part of a mechanical agent. In another example a rewards or cost may depend on energy or power usage, motion speed, or a positions of e.g. a robot, robot part or vehicle.

A task performed by a robot may be, for example, any task which involves picking up, moving, or manipulating one or more objects, e.g. to assemble, treat, or package the objects, and/or a task which involves the robot moving. A task performed a vehicle may be a task which involves the vehicle moving through the environment.

In the above described applications the same observations, actions, rewards and costs may be applied to a simulation of the agent in a simulation of the real-world environment. Once the system has been trained in the simulation, e.g. once the neural networks of the system/method have been trained, the system/method be used to control the real-world agent in the real-world environment. That is control signals generated by the system/method may be used to control the real-world agent to perform a task in the real-world environment in response to observations from the real-world environment. Optionally the system/method may continue training in the real-world environment.

In some applications the environment is a networked system and the actions comprise configuring settings of the networked system that affect the energy efficiency or performance of the networked system. A corresponding task may involve optimizing the energy efficiency or performance of the networked system. The networked system may be e.g. an electric grid or a data center. For example the described system/method may have a task of balancing the electrical grid, or optimizing e.g. renewable power generation (e.g. moving solar panels or controlling wind turbine blades), or electricity energy storage e.g. in batteries; with corresponding rewards or costs, the observations may relate to operation of the electrical grid, power generation, or storage; and the actions may comprise control actions to control operation of the electrical grid, power generation, or energy storage.

In some applications the agent may be a static or mobile software agent i.e. a computer programs configured to operate autonomously and/or with other software agents or people to perform a task. For example the environment may be a circuit or an integrated circuit routing environment and the agent may be configured to perform a routing task for routing interconnection lines of a circuit or of an integrated circuit e.g. an ASIC. The reward(s) and/or cost(s) may then be dependent on one or more routing metrics such as interconnect length, resistance, capacitance, impedance, loss, speed or propagation delay; and/or physical line parameters such as width, thickness or geometry, and design rules; or may relate to a global property such as operating speed, power consumption, material usage, cooling requirement, or level of electromagnetic emissions. The observations may be e.g. observations of component positions and interconnections; the actions may comprise component placing actions e.g. to define a component position or orientation and/or interconnect routing actions e.g. interconnect selection and/or placement actions.

In some applications the agent may be an electronic agent and the observations may include data from one or more sensors monitoring part of a plant, building, or service facility, or associated equipment, such as current, voltage, power, temperature and other sensors, and/or electronic signals representing the functioning of electronic and/or mechanical items of equipment e.g. computers or industrial control equipment. The agent may control actions in a real-world environment including items of equipment, for example in a facility such as: a data center, server farm, or grid mains power or water distribution system, or in a manufacturing plant, building, or service facility. The observations may then relate to operation of the plant, building, or facility, e.g. they may include observations of power or water usage by equipment or of operational efficiency of equipment, or observations of power generation or distribution control, or observations of usage of a resource or of waste production, or observations of the environment, e.g. air temperature. The actions may include actions controlling or imposing operating conditions on items of equipment of the plant/building/facility, and/or actions that result in changes to settings in the operation of the plant/building/facility e.g. to adjust or turn on/off components of the plant/building/facility. The equipment may include, merely by way of example, industrial control equipment, computers, or heating, cooling, or lighting equipment. The reward(s) and/or cost(s) may include one or more of: a measure of efficiency, e.g. resource usage; a measure of the environmental impact of operations in the environment, e.g. waste output; electrical or other power or energy consumption; heating/cooling requirements; resource use in the facility e.g. water use; or a temperature of the facility or of an item of equipment in the facility. A corresponding task may involve optimizing a corresponding reward or cost to minimize energy or resource use or optimize efficiency. The (extrinsic) rewards or return may relate to a metric of performance of the task. For example in the case of a task to control, e.g. minimize, use of a resource, such as a task to control use of electrical power or water, the metric may comprise any metric of use of the resource.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The (extrinsic) rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The (extrinsic) rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In some applications the environment may be a data packet communications network environment, and the agent may comprise a router to route packets of data over the communications network. The task may comprise a data routing task. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) or cost(s) may be defined in relation to one or more of the routing metrics i.e. to maximize or constrain one or more of the routing metrics.

In some other applications the agent is a software agent which has a task of managing the distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The reward(s) or cost(s) may be to maximize or limit one or more of: utilization of computing resources, electrical power, bandwidth, and computation speed.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some other applications the environment may be an in silico drug design environment, e.g. a molecular docking environment, and the agent may be a computer system with the task of for determining elements or a chemical structure of the drug. The drug may be a small molecule or biologic drug. An observation may be an observation of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. One or more rewards or costs may be defined based on one or more of: a measure of an interaction between the drug and the drug target e.g. of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on e.g. a protein-ligand bonding, van der Waal interactions, electrostatic interactions, and/or a contact surface region or energy; it may comprise e.g. a docking score.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The (extrinsic) rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some other applications the environment is an Internet or mobile communications environment and the agent is a software agent which manages a personalized recommendation for a user. The task may be to generate recommendations for the user. The observations may comprise previous actions taken by the user, e.g. features characterizing these; the actions may include actions recommending items such as content items to a user. The reward(s) or cost(s) may be to maximize or constrain one or more of: an estimated likelihood that the user will respond favorably to being recommended the (content) item, a suitability unsuitability of one or more recommended items, a cost of the recommended item(s), and a number of recommendations received by the user, optionally within a time span. In another example the recommendations may be for ways for the user to reduce energy use or environmental impact.

In some other applications the environment is a healthcare environment and the agent is a computer system for suggesting treatment for the patient. The observations may then comprise observations of the state of a patient e.g. data characterizing a health of the patient e.g. data from one or more sensors, such as image sensors or biomarker sensors, vital sign data, lab test data, and/or processed text, for example from a medical record. The actions may comprise possible medical treatments for the patient e.g. providing medication or an intervention. The task may be to stabilize or improve a health of the patient e.g. to stabilize vital signs or to improve the health of the patient sufficiently for them to be discharged from the healthcare environment or part of the healthcare environment, e.g. from an intensive care part; or the task may be to improve a likelihood of survival of the patient after discharge or to reduce long-term damage to the patient. The reward(s) or cost(s) may be correspondingly defined according to the task e.g. a reward may indicate progress towards the task e.g. an improvement in patient health or prognosis, or a cost may indicate a deterioration in patient health or prognosis.

Optionally, in any of the above implementations, the observation at any given time step may include data from a previous time step that may be beneficial in characterizing the environment, e.g., the action performed at the previous time step, the reward received at the previous time step, or both.

Once trained the system may be used to perform the task for which it was trained, optionally with training continuing during such use. The task may be, e.g., any of the tasks described above. In general the trained system may be used to control the agent to achieve rewards or minimize costs as described above. Merely by way of example, once trained the system may be used to control a robot or vehicle to perform a task such as manipulating, assembling, treating or moving one or more objects; or to control equipment e.g. to minimize energy use; or in healthcare, to suggest medical treatments.

As discussed above, the present method can be used not only for standard reinforcement-learning, but, for example, for performing one of the learning tasks listed in Table 1 which are not conventionally treated as RL problems, such as pure exploration, apprenticeship learning, imitation learning, diverse skill discovery or solving constrained MPDs. This is accomplished by an appropriate choice for the objective function ƒ, e.g. as shown in Table 1. Such non-standard RL is of value for many of the technical situations discussed above.

Examples of apprenticeship learning (AL) and imitation learning (IL) include cases where an expert performs a task (such as any of the technical tasks described above), and the present system is trained to control an agent to emulate the actions of the human expert. The expert is typically a human expert, but it may alternatively be a computer-implemented expert system of a different type from the agent which is to be controlled to perform the same task.

For example, if the environment is a real-world environment, the expert may manipulate objects and/or may control tools or manufacturing equipment to perform a task in the environment, such as a stacking task, a sorting task, a surgical task, or a manufacturing task. A training database is formed recording multiple sequences of observations (trajectories) of the expert performing this task, e.g. starting from different respective initial conditions, and the present system can use the database to learn to control an agent of any of the types discussed above (e.g. a robot, a simulated agent, etc.) to emulate the actions of the human, e.g. given an initial environment which resembles but is different from any of the initial environments in the training database. For example, the system may learn to control a robot to manipulate surgical equipment to perform surgery on animal bodies, based on a database recording sequences of observations from times when human surgeons performed the same surgery on different animals. In imitation learning, the control system learns to control the agent to emulate the actions of the expert, so as to perform the task in a way which is hard to distinguish from how the expert performed the task. In apprenticeship learning, by contrast, the control system tends to learn how to perform the task of the expert, without necessarily performing it in the same way.

An example of a pure exploration task is one in which the control system controls an agent to gather experiences from environment, solely to gain information about it. For example, an exploration can be performed using any of the real world or simulated environments described above (e.g. an real or simulated environment within which a robot moves, a manufacturing environment, a power generation facility, a data packets communication network, a drug discovery environment, a protein folding environment, an environment in which multiple molecules interact (e.g. including at least one biological molecule, that is one which known from experimental measurements to exist in a living creature in the real world), or an electro-mechanical design environment) to get an understanding about that environment, without defining any other task. This allows the agent to reach sections of the environment, or to perform sets of actions, that are not valuable to any known specific task, and indeed may have previously been unobtainable using only a single set of behaviors relevant to known tasks.

The information gained from exploring the environment may be of scientific value in itself, e.g. discovering that two experimentally-identified biological molecules have a strong interaction which was not previously suspected. Furthermore, it may be useful to gather information about the environment so that, using the information, a task can be performed subsequently (e.g. a task which has not be defined at the time of the exploration). For example, a robot can explore a real or simulated environment to discover tools within the environment which have respective functions, and subsequently a task can be defined which can be performed using a selection of those tools. In another example, if the control system explores how to control a robot to manipulate tools provided in an environment to produce products of differing shapes from raw material in the environment, or how to control manufacturing equipment to produce differing products, this knowledge can subsequently applied to perform a task of making a specific product. This is an example of “diverse skill discovery”, in which a control system learns skills which may, in some cases, be useful as components of a technique to perform a subsequently defined task.

In many of the technical situations of RL described above, learning can be more useful if it is subject to a constraint, and thus the learning constitutes a constrained MDP (CMDP) which can be addressed using the techniques described above with a learning function as shown in Table 1. For example, in the situation of controlling an electro-mechanical agent such as a robot in a real-world environment, the robot may have to be controlled so that an on-board battery is not exhausted between times at which the robot visits a charging station to refresh the battery, and/or such that no component of the robot overheats or wears out by excessive use. Similarly, a drug discovery process to discover a drug with a desired chemical function (e.g. it interacts with an experimentally identified biological molecule), may seek a drug subject to the constraint that its size does not exceed a desired size bound, and/or that it is straightforward to fabricate, and/or that it does not have another undesirable biological property (e.g. high acidity). In another example, a resource management system may have to allocate resources (e.g. computing resources) between multiple processes subject to the constraint that none of the processes receives less than a certain proportion of the computing resources.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying FIGURES do not necessarily require the particular order shown, or sequential order, to achieve desirable results. In certain implementations, multitasking and parallel processing may be advantageous.

1. A computer-implemented method of determining a policy model defining, for an observed state of an environment, a state-action distribution over a set of possible actions to be performed by an agent interacting with the environment to perform a task,
the method comprising performing a plurality of iterations, each iteration comprising obtaining both a corresponding cost model and a corresponding candidate policy model, the corresponding cost model defining, for an observed state of an environment, a reward vector comprising a corresponding reward value for each action of the set of actions, each reward value indicating a contribution the corresponding action makes to performing the task, and the policy model being obtained based on at least one of the candidate policy models;
each iteration comprising:
obtaining the corresponding cost model as a cost model which maximizes a Lagrangian function which is based on the state-action distribution defined by at least one previously generated candidate policy model and on a convex function of a reward vector defined by the corresponding cost model; and
obtaining the corresponding candidate policy model for the iteration based on the reward vector defined by the cost model obtained in the iteration.

2. The method of claim 1 in which the Lagrangian function comprises: (a) a dot product of the reward vector defined by the cost model with the state-action distribution defined by at least one previously generated candidate policy model, minus (b) the convex function of the reward vector defined by the cost model.

3. The method of claim 1, further comprising generating an average state-action distribution which, for an observed state of an environment, defines a state-action distribution over a set of possible actions to be performed by an agent,
the average distribution being an average, over a plurality of the iterations, of the respective state-action distribution for the respective candidate policy model obtained in each of those iterations.

4. The method of claim 3 further comprising determining the policy model by using the average state-action distribution to derive a policy model which defines a state-action distribution equal to the average state-action distribution.

5. The method of claim 1, in which the convex function of the reward vector defined by the cost model is based on training data comprising instances of states of the environment and corresponding actions.

6. The method of any of claim 5, in which the training data comprises a plurality of trajectories, each trajectory comprising a sequence of observed consecutive states of the environment and corresponding actions performed when the environment was in the observed state.

7. The method of claim 5, in which, in each of the iterations, at least one corresponding action is selected based on an observed state of the environment, the at least one corresponding action being selected based on a state-action distribution obtained using at least one of the previously obtained candidate policy models, the observed state and the corresponding selected action being used to form an additional training data item which is added to the training data.

8. The method of claim 1, in which the convex function is Fenchel conjugate function of an objective function, the objective function being indicative, when the argument of the objective function is a state-action distribution, of how well actions chosen based on the state-action distribution contribute to solving the task.

9. The method of claim 8, in which said obtaining the corresponding cost model for the iteration comprises deriving the reward vector defined by the corresponding cost model as a gradient of the objective function, where the gradient of the objective function is evaluated for a state-action distribution based on the state-action distributions for one or more of the candidate policy models.

10. The method of claim 9 in which the gradient of the objective function is evaluated for a state-action distribution which is an average of the state-action distributions for the corresponding candidate policy models obtained in a plurality of the previous iterations.

11. The method of claim 1, in which the candidate policy model obtained in each iteration is obtained as a candidate policy model, chosen from a range of possible candidate policy models, which maximises a dot product of the reward vector corresponding to the cost model obtained in the iteration with the distribution defined by the candidate policy model.

12. The method of claim 1, in which the candidate policy model obtained in each iteration is derived by one or more iterative update steps taking a starting point the policy model for the preceding iteration.

13. The method of claim 1, in which the Lagrangian function includes terms implementing one or more constraints, and defined based on one or more corresponding Lagrangian variables, the step of deriving the cost model further including maximizing the Lagrangian function with respect to the Lagrangian variables.

14. The method of claim 13 in which at least one said constraint enforces a constraint that the entropy of the state-action distribution defined by each candidate policy model is at least a predetermined value.

15. The method of claim 1, wherein the observation relates to a real-world environment and wherein the selected action relates to an action to be performed by a mechanical agent, the method further comprising using the policy model to control a mechanical agent to perform the task while interacting with a real-world environment by obtaining the observations from one or more sensors sensing the real-world environment and using the state-action distribution to select actions to control the mechanical agent to perform the task.

16. A system comprising one or more computers and one or more storage devices storing instructions that when executed by the one or more computers cause the one or more computers to operations for determining a policy model defining, for an observed state of an environment, a state-action distribution over a set of possible actions to be performed by an agent interacting with the environment to perform a task,
the operations comprising performing a plurality of iterations, each iteration comprising obtaining both a corresponding cost model and a corresponding candidate policy model, the corresponding cost model defining, for an observed state of an environment, a reward vector comprising a corresponding reward value for each action of the set of actions, each reward value indicating a contribution the corresponding action makes to performing the task, and the policy model being obtained based on at least one of the candidate policy models;
each iteration comprising:
obtaining the corresponding cost model as a cost model which maximizes a Lagrangian function which is based on the state-action distribution defined by at least one previously generated candidate policy model and on a convex function of a reward vector defined by the corresponding cost model; and
obtaining the corresponding candidate policy model for the iteration based on the reward vector defined by the cost model obtained in the iteration.

17. One or more non-transitory computer storage media storing instructions that when executed by one or more computers cause the one or more computers to perform operations for determining a policy model defining, for an observed state of an environment, a state-action distribution over a set of possible actions to be performed by an agent interacting with the environment to perform a task,
the operations comprising performing a plurality of iterations, each iteration comprising obtaining both a corresponding cost model and a corresponding candidate policy model, the corresponding cost model defining, for an observed state of an environment, a reward vector comprising a corresponding reward value for each action of the set of actions, each reward value indicating a contribution the corresponding action makes to performing the task, and the policy model being obtained based on at least one of the candidate policy models;
each iteration comprising:
obtaining the corresponding cost model as a cost model which maximizes a Lagrangian function which is based on the state-action distribution defined by at least one previously generated candidate policy model and on a convex function of a reward vector defined by the corresponding cost model; and
obtaining the corresponding candidate policy model for the iteration based on the reward vector defined by the cost model obtained in the iteration.

18. The non-transitory computer storage media of claim 17, in which the Lagrangian function comprises: (a) a dot product of the reward vector defined by the cost model with the state-action distribution defined by at least one previously generated candidate policy model, minus (b) the convex function of the reward vector defined by the cost model.

19. The non-transitory computer storage media of claim 17, wherein the operations further comprise generating an average state-action distribution which, for an observed state of an environment, defines a state-action distribution over a set of possible actions to be performed by an agent, the average distribution being an average, over a plurality of the iterations, of the respective state-action distribution for the respective candidate policy model obtained in each of those iterations.

20. The non-transitory computer storage media of claim 19, wherein the operations further comprise determining the policy model by using the average state-action distribution to derive a policy model which defines a state-action distribution equal to the average state-action distribution.
